(19) United States
(12) Patent Application Publication
(10) Pub. No.: US 2008/0167046 A1
(43) Pub. Date: Jul. 10, 2008

(54) Method of mobile terminal for handover/switch among different wireless communication networks in a heterogeneous network environment

(75) Inventors: Tung-Yi Liao, Taipei City (TW); Chih-Wei Su, Taipei City (TW); Wen-Hsin Wei, Taipei City (TW)

Correspondence Address: RABIN & Berdo, PC, 1101 14TH STREET, NW, SUITE 500, WASHINGTON, DC, 20005, US

(73) Assignee: INSTITUTE FOR INFORMATION INDUSTRY, Taipei City (TW)

(21) Appl. No.: 11/649,201

(22) Filed: Jan. 4, 2007

(51) Int. Cl. H04Q 7/20

(52) U.S. Cl. 455/441; 455/436

(57) ABSTRACT

A method of mobile terminal for handover/switch among different wireless communication networks in a heterogeneous network environment is provided. The presented method can optimize battery life by switching off the radio functionality or signal detector when it is not required, based on the movement information, ex. velocity, of the mobile terminal in the heterogeneous wireless communication network. This method will determine an optimal time to turn off the signal detector for minimizing the power consumption. Furthermore, when the mobile terminal moves continuously but the coverage of the preferred wireless network is relatively small, this method can also avoid redundant and unnecessary handover for keeping the communication quality stable, and reduce the loading of frequent handover in the heterogeneous network.

### BACKGROUND OF THE INVENTION

1. Field of Invention

The invention related to wireless communication networks, and more particularly to switch and handover within a heterogeneous network environment including more than one type of wireless network.

2. Related Art

The wireless or mobile telephone is no longer simply used for voice transmission. Although voice transmission remain a primary function for many of these communication devices, these devices are being called on to provide the same communication data exchange services demanded by ground based fixed location or hard path communication systems (optical and/or wire), including the transmission of vast amounts of data through public or private internet connections. The mobility and high data transmission rates requirement of the wireless units presents challenges and problems never before experienced by ground based fixed location systems.

A mobile handset or a voice-capable PDA has voice communication capability. The mobile handset may include capabilities of sending, receiving, and forwarding data via the wireless communication channel provided by any of wireless data communication network interfaces. Therefore, heterogeneous network containing multiple wireless access techniques become more and more prevalent nowadays. A mobile terminal may include two or more wireless communication interfaces for use in the heterogeneous network.

In the heterogeneous network, priority of each wireless communication networks is set up first. When signal intensity or quality of the preferred communication network is poor, the signal detector of mobile terminal searches another wireless communication network with the next priority. However, when the mobile terminal moves continuously but the coverage of the preferred network is relatively small (e.g. WLAN), this may cause frequent network switch or handover and result in decrease of quality of service, and even the voice communication may become off line because of handover failure. Further, continuous network search for the preferred communication network may cause unnecessary and redundant power consumption.

### SUMMARY OF THE INVENTION

This disclosure is directed to a method for switching/handovering among different wireless communication networks for a mobile terminal having a moving information detector, e.g. GPS, for detecting the movement information.

Based on the movement information, ex. velocity, of the handset in the heterogeneous wireless network, the presented method can optimize battery life by switching off the radio functionality or signal detector when it is not required. The method can be applied to both standby mode and dedicated mode of the mobile terminal. Moreover, the presented method can also avoid frequent and redundant handover such that the quality of service can be maintained and keep voice transmission stable.

In one embodiment, the disclosure provides a method to minimize the power consumption of network switch/handover. When the moving velocity of the mobile terminal is smaller than the upper velocity limitation of the preferred wireless network, the signal detector should be turned on for searching the preferred wireless network, and then switching into the preferred wireless network if the signal can be detected by signal detector. Oppositely, when the moving velocity of the mobile terminal is greater than the upper velocity limitation of the preferred wireless network, the signal detector can be turned off to reduce unnecessary power consumption.

In another embodiment, the disclosure provides a method to minimize the power consumption of network switch/handover. When the mobile terminal is not moving and static, the signal detector should be turned on for detecting the existence of the preferred wireless network. However, if the preferred wireless network is not detected then, the signal detector can be turned off for saving power consumption, until the mobile terminal starts to move but its moving velocity is smaller than the upper velocity limitation of the preferred wireless network, such that the signal detector is turned on again for detecting the existence of the preferred wireless network.

In another embodiment, when the mobile terminal moves continuously but the coverage of the preferred network is relatively small, the disclosure also provides a method to avoid redundant and unnecessary handover for keeping the communication quality stable, and reduce the loading of frequent handover in the heterogeneous network.

The techniques described herein may be implemented in hardware, software, firmware, or any combination thereof. If implemented in software, the techniques may be directed to a readable medium comprising program code, that when executed, performs one or more of the techniques described herein.

Further scope of applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given herein below for illustration only, and which thus is not limitative of the present invention, and wherein:

FIG. 1 is a block diagram illustrating a heterogeneous communication environment that contains multiple wireless access techniques.

FIG. 2 is a block diagram illustrating a mobile terminal used in the heterogeneous communication environment of FIG. 1.

FIG. 3 is a flow diagram illustrating the network switch process when the mobile terminal is in standby mode.

FIG. 4 is a flow diagram illustrating the network handover process when the mobile terminal is in voice communication.

### DETAILED DESCRIPTION OF THE INVENTION

The detailed features and advantages of the present invention are discussed in detail in the following embodiments. Those skilled in the related arts can easily understand the technical content of the present invention, and can implement it accordingly. Furthermore, the objects and advantages of the present invention will be apparent to those skilled in the related arts according to the content of the specification, claims, and drawings.

Certain terminology is used in the following description for convenience only and is not limiting. The terminology includes the words specifically mentioned below, derivatives thereof and words of similar import.

“Heterogeneous network” refers to a wireless communication network environment including multiple wireless communication networks of different communication technology.

“Network in use” refers to a specific communication technology employed for voice or data communication at the moment.

“Preferred network” refers to a network of a specific communication technology designated by a user, which is not necessary in use.

“Network switch” refers to selection of communication technology when a mobile terminal is in standby mode.

“Network handover” refers to selection of communication technology when a mobile terminal is in voice or data communication.

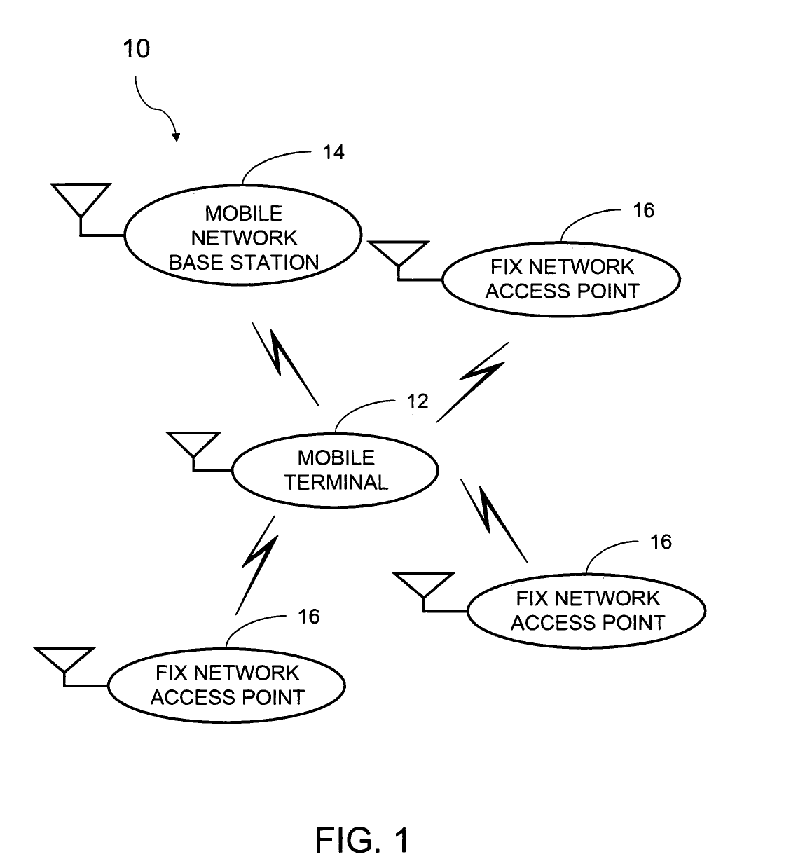

FIG. 1 is a block diagram illustrating a wireless communication environment. As shown in FIG. 1, the wireless communication environment 10 is a heterogeneous network including one or more wireless communication networks such as Wireless Wide Area Network (WWAN), Wireless Metro Area Network (WMAN), Wireless Local Area Network (WLAN), and Wireless Personal Area Network (WPAN). One or more mobile terminals 12 may be configured to provide voice or data communication via two or more wireless network interfaces. Each wireless network interface permits voice or data communication with one or more wireless network access points 14 that may be available within a given wireless coverage area.

The voice or data communicated by mobile terminals 12 may be in the form of packet data, packet voice data, or circuit voice data. Furthermore, the voice or data communicated may result from local applications running on mobile terminals 12.

For purposes of illustration, as shown in FIG. 1, a given wireless communication environment may provide a variety of mobile network base stations 14 such as an AMPS base station, an IS95 CDMA base station, a WCDMA base station, a CDMA2000 base station, a GSM base station, a GPRS base station, and/or fix network access points 16 such as Bluetooth network access point and an IEEE 802.11 access point. IEEE 802.11 access point may be, for example, an IEEE 802.11(a), 802.11(b) or 802.11(g) access point. The types, number, and variety of network access points shown in FIG. 1 are purely for purposes example, and should not be considered limiting of the techniques broadly described and embodied in this disclosure.

For purposes of illustration, as shown in FIG. 1, a given coverage area may provide a variety of wireless network access points

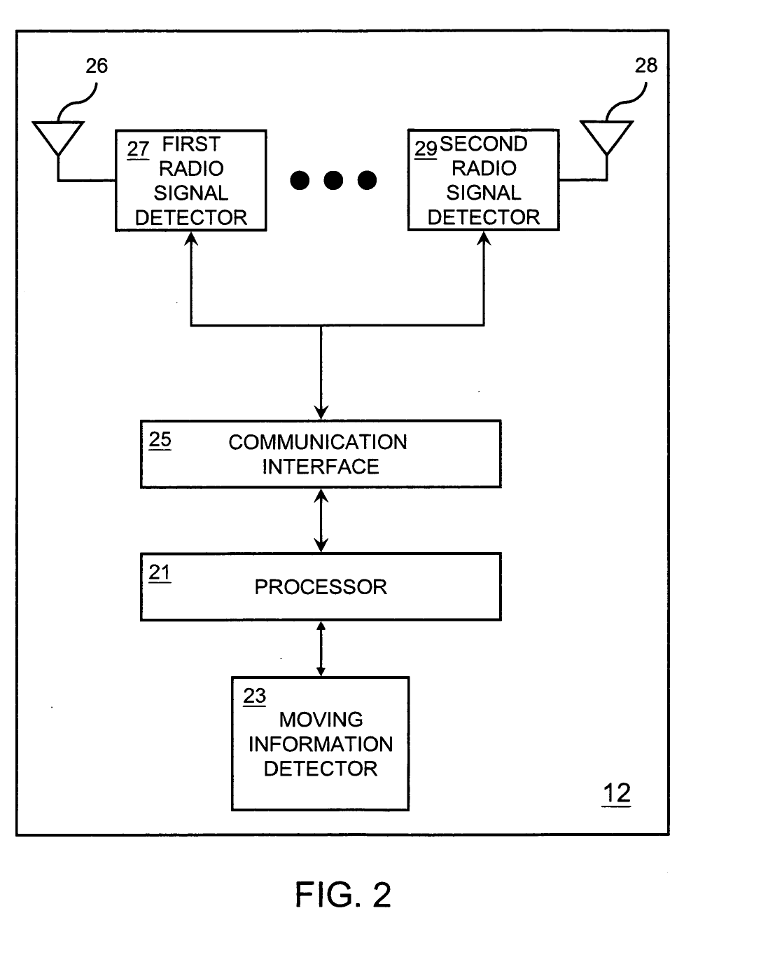

FIG. 2 is a block diagram illustrating an example mobile terminal used in the wireless communication environment in FIG. 1.

The mobile terminal 12 may employ a variety of communication techniques for data and voice communication, including those represented by the various wireless access points illustrated in FIG. 1.

The mobile terminal 12 may include a processor 21, a moving information detector 23, a communication interface 25 having several wireless network interfaces, and one or more first radio signal detector 27 and second radio signal detector 29, respectively. The first radio signal detector 27 is used for mobile network. The first radio signal detector 27 may transmit and receive wireless signals carrying packetized data over a radio-frequency antenna 26 providing connectivity to a mobile network. The second radio signal detector 29 is used for short-range wireless network. The second radio signal detector 29 may transmit and receive wireless signals over a radio-frequency antenna 28 that provides connectivity to a short-range wireless network such as local area network or personal area network.

The processor 21 may select one of several wireless network interfaces to serve packets associated with different communication applications running on the mobile terminal 12.

The communication interface 25 having several wireless network interfaces may be realized by shared or dedicated hardware components, programmable features, or a combination thereof.

The moving information detector 23 may be the form of a location detector of detecting the location of the mobile terminal. The moving information 23 may also be the form of a velocity detector of detecting the velocity of the mobile terminal. The detected location or the detected velocity is used for moving information.

The moving information detector 23 may be realized by Global Position System (GPS) or Assisted GPS (A-GPS). Several positions of the mobile terminal 12 will be collected when moving. The moving velocity may be determined by using the collected positions divided by a time period.

The first radio signal detector 27 and the second radio signal detector 29 are used for detecting the signals of a specific wireless communication network such as a network in use or a preferred network, in response to the detected moving velocity by the moving information detector 23. When the moving velocity of the mobile terminal 12 exceeds an upper velocity limitation of a specific wireless communication network, the signal detectors 27 and 29 can be turned off for power saving. When the moving velocity of the mobile terminal 12 is lower than the upper velocity limitation, the signal detectors 27 and 29 are turned on to detect the signals. More explanation will be described in the following figures.

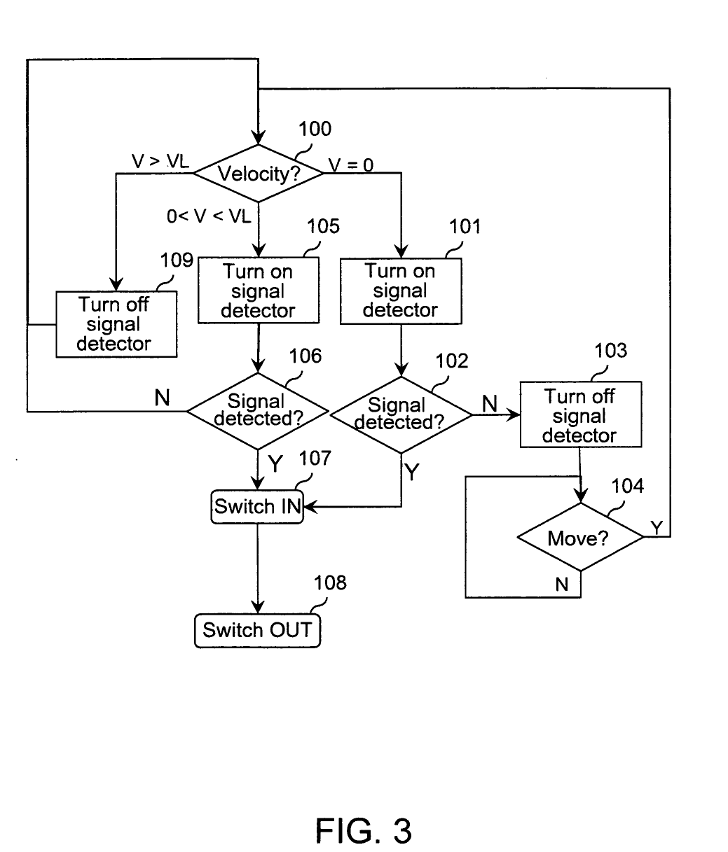

FIG. 3 is a flow diagram illustrating the network switch process when the mobile terminal is in standby mode.

The current moving velocity of the mobile terminal is first determined (step 100). An upper velocity limitation VL of a preferred network is determined when a preferred network is selected. If the moving velocity is smaller than the upper velocity limitation, the signal detector for the preferred network is turned on.

Zero velocity refers to no movement of the mobile terminal. If the moving velocity is zero, the signal detector for the preferred network is turned on (step 101) to search the existence of the preferred wireless network. If the signal detector reports that the preferred network is not detected (step 102), the signal detector for the preferred network is turned off (step 103) since the current location of the mobile terminal is not covered by the preferred network. Then check if the mobile terminal moves or not (step 104). If movement of the mobile terminal is detected, then determine the moving velocity of the mobile terminal (step 100).

If the moving velocity is not zero and smaller than the upper velocity limitation (step 100), the signal detector for the preferred network is turned on (step 105) to search the existence of the preferred wireless network. If signal of the preferred network is not detected (step 106), then determine the move velocity of the mobile terminal (step 100).

In step 102 and step 106, if signal of the preferred network can be detected, the network in use is switched into the preferred network (step 107). Then if the mobile terminal switches out of the preferred network later (step 108), the process goes back to step 100.

If the moving velocity is greater than the upper velocity limitation (step 100), the signal detector for the preferred network is turned off (step 109) since the mobile terminal moves too fast to access the preferred wireless network, and then the process goes to step 100.

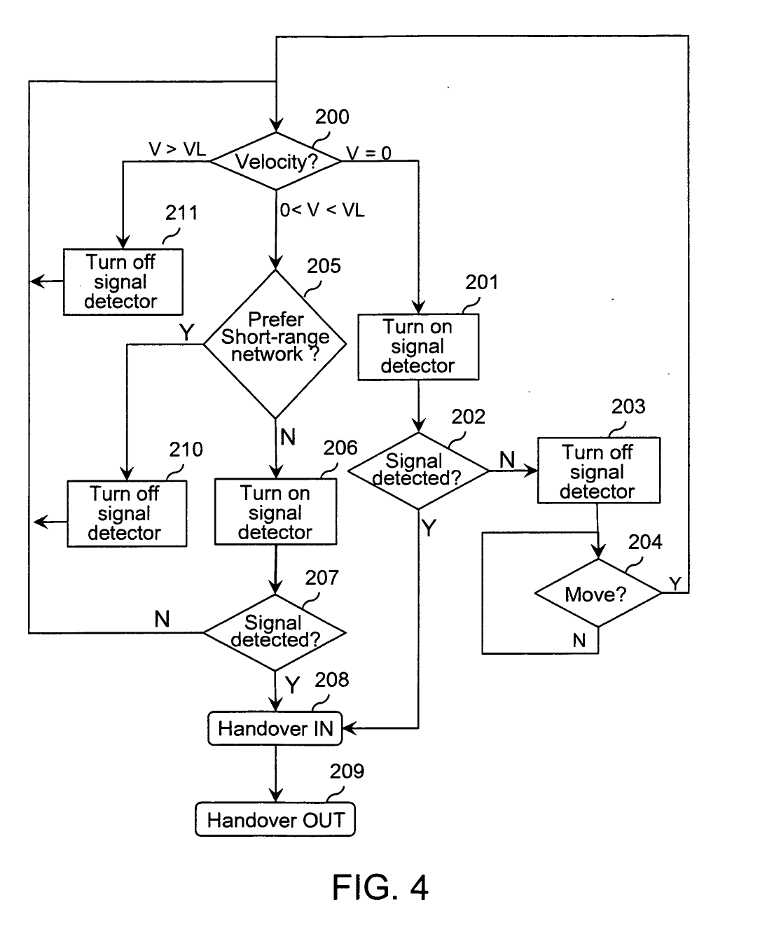

FIG. 4 is a flow diagram illustrating the network handover process when the mobile terminal is in voice communication.

The current moving velocity of the mobile terminal is first determined (step 200). An upper velocity limitation of a preferred network is determined when a preferred network is selected. If the moving velocity is smaller than the upper velocity limitation, the signal mobile terminal, and step 201 to step 204 is similar to step 101 to step 104 illustrated in above description and FIG. 3.

If the mobile terminal is continuously moving and its speed is smaller than the upper velocity limitation (step 200), then the process checks whether the preferred network belongs to a short-range wireless network or not (step 205). Since a short-range wireless network, e.g. bluetooth, WiFi, is not suitable for mobile communication even it may have high data rate, the mobile terminal turns off the signal detector of the short-range wireless network which is also the preferred network (step 210). Then the process goes back to step 200. On the other hand, if the preferred network does not belong to short-range wireless network, e.g. GSM, UMTS that have better mobility and coverage (step 205), then the signal detector should be turned on to search the preferred network for handover (step 206).

In step 202 and step 207, if signal of the preferred network is detected, the voice communication will handover from the network in use to the preferred network (step 208). Then if the voice communication handover out of the preferred network (step 209) later, the process goes back to step 200.

If the moving velocity is greater than the upper velocity limitation (step 200), the signal detector for the preferred network is turned off (step 211) since the mobile terminal moves too fast to access the preferred wireless network, and then the process goes to step 200.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A method for switching among different wireless communication networks for a mobile terminal having at least a signal detector for detecting a wireless communication work, comprising:
detecting a moving velocity of the mobile terminal;
turning on the signal detector for detecting the preferred wireless communication network when the moving velocity of the mobile terminal is smaller than the upper velocity limitation of the preferred wireless communication work;
receiving the signals of the preferred wireless communication network if the signals are detected after turning on the signal detector; and
switching into the preferred wireless communication network after receiving the signals.

2. The method of claim 1, further comprising a step of turning off the signal detector for detecting the preferred wireless communication network if the signals of the preferred wireless communication network are not detected after turning on the signal detector.

3. The method of claim 2, further comprising a step of detecting movement of the mobile terminal after turning off the signal detector for detecting the preferred wireless communication work.

4. The method of claim 1, further comprising going back to the step of detecting the moving velocity of the mobile terminal if the signals of the preferred wireless communication network are not detected after turning on the signal detector.

5. The method of claim 1, further comprising a step of turning off the signal detector for detecting the preferred wireless communication network when the moving velocity of the mobile terminal is greater than the upper velocity limitation of the preferred wireless communication work.

6. The method of claim 2, further comprising going back to the step of detecting the moving velocity of the mobile terminal after turning off the signal detector for detecting the preferred wireless communication work.

7. A mobile terminal for switching among different wireless communication networks, comprising:
a velocity detector detecting a moving velocity of the mobile terminal;
a signal detector for detecting signals of a specific wireless communication network;
a communication interface having a plurality of interfaces corresponding to the wireless communication networks; and
a processor for turning on the signal detector for detecting a preferred wireless communication network when the moving velocity of the mobile terminal is smaller than the upper velocity limitation of the preferred wireless communication work, receiving the signals of the preferred wireless communication network if the signals are detected after turning on the signal detector, and switching into the preferred wireless communication network after receiving the signals.

8. The mobile terminal of claim 7, wherein the processor turns off the signal detector for detecting the preferred wireless communication network if the signals of the preferred wireless communication network are not detected after turning on the signal detector.

9. The mobile terminal of claim 8, wherein the velocity detector detects movement of the mobile terminal after turning off the signal detector for detecting the preferred wireless communication work.

10. The mobile terminal of claim 7, wherein the velocity detector detects the moving velocity of the mobile terminal if the signals of the preferred wireless communication network are not detected after turning on the signal detector.

11. The mobile terminal of claim 7, wherein the processor turns off the signal detector for detecting the preferred wireless communication network when the move velocity of the mobile terminal is greater than the upper velocity limitation of the preferred wireless communication work.

12. The mobile terminal of claim 11, wherein the velocity detector detects the moving velocity of the mobile terminal after turning off the signal detector for detecting the preferred wireless communication work.

13. A record medium comprising instructions that cause a mobile terminal having at least a signal detector for detecting a wireless communication network to executing steps of:
detecting a moving velocity of the mobile terminal;
turning on the signal detector for detecting the preferred wireless communication network when the moving velocity of the mobile terminal is smaller than the upper velocity limitation of the preferred wireless communication work;
receiving the signals of the preferred wireless communication network if the signals are detected after turning on the signal detector; and
switching into the preferred wireless communication network after receiving the signals

14. The record medium of claim 13, further comprising a step of turning off the signal detector for detecting the preferred wireless communication network if the signals of the preferred wireless communication network are not detected after turning on the signal detector.

15. The record medium of claim 14, further comprising a step of detecting movement of the mobile terminal after turning off the signal detector for detecting the preferred wireless communication work.

16. The record medium of claim 13, further comprising going back to the step of detecting the moving velocity of the mobile terminal if the signals of the preferred wireless communication network are not detected after turning on the signal detector.

17. The record medium of claim 13, further comprising a step of turning off the signal detector for detecting the preferred wireless communication network when the moving velocity of the mobile terminal is greater than the upper velocity limitation of the preferred wireless communication work.

18. The record medium of claim 17, further comprising going back to the step of detecting the moving velocity of the mobile terminal after turning off the signal detector for detecting the preferred wireless communication work.

19. A method for handover among different wireless communication networks for a mobile terminal having at least a signal detector for detecting a preferred wireless communication work, comprising:
detecting a moving velocity of the mobile terminal;
turning on the signal detector for detecting the preferred wireless communication network when the moving velocity of the mobile terminal is zero;
checking whether the preferred network belongs to a short-range wireless network or not when the moving velocity of the mobile terminal is not zero and is smaller than the upper velocity limitation of the preferred wireless communication work;
turning on the signal detector for detecting the preferred wireless communication network when the preferred network does not belong to short-range wireless network;
receiving the signals of the preferred wireless communication network if the signals of the preferred wireless communication network are detected after turning on the signal detector; and
handovering to the preferred wireless communication network after receiving the signals.

20. The method of claim 19, further comprising a step of turning off the signal detector for detecting the preferred wireless communication network when the preferred wireless communication network is not detected.

21. The method of claim 20, further comprising a step of detecting movement of the mobile terminal after turning off the signal detector for detecting the preferred wireless communication work.

22. The method of claim 19, further comprising going back to the step of detecting the moving velocity of the mobile terminal when the signals of the preferred wireless communication network are not detected.

23. The method of claim 19, further comprising a step of turning off the signal detector for the short-range wireless network when the preferred wireless communication network belongs to a short-range wireless network.

24. The method of claim 19, further comprising a step of turning off the signal detector for detecting the preferred wireless communication network when the move velocity of the mobile terminal is greater than the upper velocity limitation of the preferred wireless communication work.

25. The method of claim 24, further comprising going back to the step of detecting the moving velocity of the mobile terminal after turning off the signal detector for detecting the preferred wireless communication work.

26. A mobile terminal for handover among different wireless communication networks, comprising:
a velocity detector detecting a moving velocity of the mobile terminal;
a signal detector for detecting signals of a specific wireless communication network;
a communication interface having a plurality of interfaces corresponding to the wireless communication networks; and
a processor for turning on the signal detector for detecting a preferred wireless communication network when the moving velocity of the mobile terminal is zero, checking whether the preferred network belongs to a short-range wireless network or not when the moving velocity of the mobile terminal is not zero and is smaller than the upper velocity limitation of the preferred wireless communication work, turning on the signal detector for detecting the preferred wireless communication network when the preferred network does not belong to short-range wireless network, receiving the signals of the preferred wireless communication network if the signals of the preferred wireless communication network are detected after turning on the signal detector, and handovering to the preferred wireless communication network after receiving the signals.

27. The mobile terminal of claim 26, wherein the processor turns off the signal detector for detecting the preferred wireless communication network when the preferred wireless communication network is not detected.

28. The mobile terminal of claim 27, wherein the velocity detector detects movement of the mobile terminal after turning off the signal detector for detecting the preferred wireless communication work.

29. The mobile terminal of claim 26, wherein the velocity detector detects the moving velocity of the mobile terminal when the signals of the preferred wireless communication network are not detected.

30. The mobile terminal of claim 26, wherein the processor turns off the signal detector for the short-range wireless network when the preferred wireless communication network belongs to a short-range wireless network.

31. The mobile terminal of claim 26, wherein the processor turns off the signal detector for detecting the preferred wireless communication network when the move velocity of the mobile terminal is greater than the upper velocity limitation of the preferred wireless communication work.

32. The mobile terminal of claim 26, wherein the velocity detector detects the moving velocity of the mobile terminal after turning off the signal detector for detecting the preferred wireless communication work.

33. A record medium comprising instructions that cause a mobile terminal having at least a signal detector for detecting a preferred wireless communication network to executing steps of:
detecting a moving velocity of the mobile terminal;
turning on the signal detector for detecting the preferred wireless communication network when the moving velocity of the mobile terminal is zero;
checking whether the preferred network belongs to a short-range wireless network or not when the moving velocity of the mobile terminal is not zero and is smaller than the upper velocity limitation of the preferred wireless communication work;
turning on the signal detector for detecting the preferred wireless communication network when the preferred network does not belong to short-range wireless network;
receiving the signals of the preferred wireless communication network if the signals of the preferred wireless communication network are detected after turning on the signal detector; and
handovering to the preferred wireless communication network after receiving the signals.

34. The record medium of claim 33, further comprising a step of turning off the signal detector for detecting the preferred wireless communication network when the preferred wireless communication network is not detected.

35. The record medium of claim 34, further comprising a step of detecting movement of the mobile terminal after turning off the signal detector for detecting the preferred wireless communication work.

36. The record medium of claim 33, further comprising going back to the step of detecting the moving velocity of the mobile terminal when the signals of the preferred wireless communication network are not detected.

37. The record medium of claim 33, further comprising a step of turning off the signal detector for the short-range wireless network when the preferred wireless communication network belongs to a short-range wireless network.

38. The record medium of claim 33, further comprising a step of turning off the signal detector for detecting the preferred wireless communication network when the move velocity of the mobile terminal is greater than the upper velocity limitation of the preferred wireless communication work.

39. The record medium of claim 38, further comprising going back to the step of detecting the moving velocity of the mobile terminal after turning off the signal detector for detecting the preferred wireless communication work.
